(19) United States
(12) Patent Application Publication
(10) Pub. No.: US 2014/0255681 A1
(43) Pub. Date: Sep. 11, 2014

(54) DIFFERENTIAL DUAL FUNCTIONAL FOAM TAPES

(71) Applicant: Avery Dennison Corporation, Glendale, CA (US)

(72) Inventors: Thomas C. EPPLE, Madison, OH (US); Chan U. KO, Arcadia, CA (US); Robert MEDSKER, Avon, IN (US); Sid SRIVASTAVA, Glendale, CA (US)

(73) Assignee: Avery Dennison Corporation, Glendale, CA (US)

(21) Appl. No.: 14/197,521

(22) Filed: Mar. 5, 2014

Related U.S. Application Data
(60) Provisional application No. 61/882,422, filed on Sep. 25, 2013.
(60) Provisional application No. 61/913,520, filed on Dec. 9, 2013.
(60) Provisional application No. 61/772,742, filed on Mar. 5, 2013.

(51) Int. Cl. C09J 7/02

(52) U.S. Cl. CPC C09J 7/0289; C09J 7/0214; C09J 7/0217; C09J 7/02; C09J 2205/31; C09J 2203/30; C09J 2409/00; C09J 2205/102
USPC 428/317.3; 428/317.1; 156/60; 427/487; 427/208.4; 427/208; 427/505

(57) ABSTRACT

An adhesive tape comprising a core layer comprising a foam and having a first surface and a second surface opposite the first surface. The adhesive tape also comprises a first adhesive layer disposed about the first surface. And, the adhesive tape also comprises a second adhesive layer disposed about the second surface. At least one of the first and second adhesive layers comprises a radiation curable rubber based adhesive. The tapes are suitable for bonding an article to a target substrate having a low surface energy and for bonding under a variety of atmospheric conditions including at elevated temperatures.

### CROSS REFERENCES TO RELATED APPLICATIONS

The present application claims the benefit of U.S. Provisional Patent Application No. 61/882,422 filed on Sep. 25, 2013; U.S. Provisional Patent Application No. 61/913,520 filed on Dec. 9, 2013; and U.S. Provisional Patent Application No. 61/772,742 filed on Mar. 5, 2013, all of which are incorporated herein by reference in their entireties.

### FIELD

This disclosure relates to adhesive tape constructions and in particular to double-sided adhesive tape constructions. The adhesive constructions can be used to adhere an article to a target substrate and are suitable in a variety of applications including bonding articles to low surface energy surfaces, and in many cases without the use of primers on the low surface energy substrates.

### BACKGROUND

Pressure sensitive adhesives (“PSAs”), are typically viscoelastic materials that adhere instantaneously to most substrates with the application of slight pressure and remain permanently tacky. PSAs are being used in more challenging environments as they become stronger and easier to apply. Such uses include industrial applications including home appliances and automotive applications such as for mounting various parts on an automobile, including dashboard parts, body panels, etc.

Low surface energy (“LSE”) materials such as polypropylene and steel coated with LSE paints are increasingly used in the automobiles. LSE materials also are increasingly used in consumer electronic applications, and in manufacture of home appliances. In the automotive industry, for example, parts such as body side moldings, weather seal foams, badges or emblems, (e.g., manufacturer logos or tags) are bonded to various substrates, typically polypropylene and painted steel, through the use of such PSAs. Such applications require high cohesive strength and high adhesion to LSE/non-polar surfaces as well as resistance to elevated temperatures and good ultraviolet (“UV”) light resistance and aging properties.

Unfortunately, substrates composed of LSE materials such as polypropylene, polyethylene, and new generation automotive paints and clear coats are extremely difficult to adhere to, particularly with PSAs. Key factors contributing to this difficulty are (1) the surface energies of conventional PSAs (such as acrylics) being higher than those of the target substrates (which limits the contact area between the PSA and the substrate surface because the PSA can not readily wet the surface of the substrate), and (2) a general lack of specific loci for covalent or strong non-covalent bonding (e.g., hydrogen or ionic bonding) on the surfaces, which means that adhesion must occur primarily through weaker van der Waals forces.

Common strategies used to obtain satisfactory adhesion to LSE substrates include lowering the surface energies of the PSAs through appropriate choice of polymer composition or additives such as tackifiers, decreasing the modulus of the composition through decreased crosslinking and/or heavy use of tackifiers, and changing the nature of the surface of the LSE substrates through use of relatively more polar primers. The first two strategies generally lead to unsatisfactory results because the cohesive strength of the PSAs typically decreases due to both tackification and decreased crosslinking, and there is a progressively increasing market need for PSAs that simultaneously possess high cohesive strength and high adhesion. The use of more polar primers can yield satisfactory results with respect to PSA performance, but requires additional primer coating and drying steps to be added to the process.

Another approach to addressing adhesion issues involves the use of primers. Priming a surface can significantly improve initial and ultimate adhesion to many materials such as plastics and paints because of their low surface energy. However, in many cases, priming a surface is not desirable due to additional processing and time involved, and in certain instances, requires a permit to use solvent based primers due to local air quality regulations.

Another approach to addressing adhesion issues involves the tackification of acrylics to improve adhesion to low energy surfaces such as polypropylene or polyethylene. Patents that disclose such PSAs include U.S. Pat. Nos. 4,418,120, 4,726,982, 4,988,742, and 5,028,484, and European Publication No. 303430, each of which are incorporated herein by reference in their entireties. These patents relate to tackification of the acrylic phase in order to improve adhesion properties. A number of these patents necessitate the use of a UV, on-web polymerization process. Because some use rosin ester type tackifiers, they would be expected to have poor UV and oxidative stability.

Another approach to improving adhesion utilizes acrylic polymers and elastomers in two phase systems. Representative patents include U.S. Pat. Nos. 4,243,500, 5,024,880, 5,143,972 and European Publication Nos. 349216 and 352901, each of which are incorporated by reference herein in their entireties. These patents involve using a UV-polymerization process to obtain a two phase network, as UV light is essential to achieve crosslinking between the acrylic and the unsaturation in the elastomer.

Grafting a saturated hydrocarbon macromer onto an acrylic backbone will yield a two phase compound consisting of a graft (or comb-type) copolymer evincing all of the desirable qualities mentioned above. These compounds are described in U.S. Pat. No. 5,625,005, which is incorporated by reference herein in its entirety. U.S. Pat. Nos. 6,670,417 and 6,642,298, which are incorporated by reference herein in their entireties describe improving upon the compounds disclosed in U.S. Pat. No. 5,625,005.

Within the context of automobile manufacturing and similar applications, a particularly popular use of PSAs is for bonding body side molding parts and weather seal rubbers to painted surfaces. The materials to be bonded, i.e., thermoplastic polyolefins (“TPOs”), rubbers and automotive paints, are LSE materials. PSAs used to bond these materials are therefore typically tackified and/or plasticized. Tackifiers and plasticizers (modifiers) are, for the most part, low molecular weight materials that are not covalently bonded to the PSA polymer. The modifiers have a two fold beneficial impact on the PSA material characteristics because they increase the bond strength that can be obtained with the PSAs.

On one hand, the modifiers lower the surface energy of the PSAs so that the surface energies of the PSAs are better matched to those of the substrates. Such matching of the surface energies ensures that the PSAs will tend to spontaneously wet out the substrate, thereby increasing the contact area. The PSA performance modifiers invariably consist of materials with solubility parameters similar to those of the substrates. Because the substrates to be bonded consist of LSE materials such as TPOs and painted surfaces, the PSA modifiers generally consist of low solubility parameter materials such as pure hydrocarbons and silicones. The modifiers also alter the rheological or viscoelastic characteristics of the PSAs. They decrease the modulus of the PSAs so the materials tend to flow better, which increases contact area in a given amount of time.

In the context of foam constructions, use of PSA performance modifiers can have negative consequences in instances where the solubility parameters of the foam materials are similar to those of the PSA performance modifiers. The PSA additives tend to migrate into the foams because the tackifier and/or plasticizer molecules are not covalently bonded to the PSA, the modifiers possess relatively low molecular weights, and the modifiers possess solubility parameters similar to those of the foams. This migration has the following two negative consequences: it depletes the PSA of the performance-enhancing additives and alters the foam performance characteristics (i.e., it tackifies and/or plasticizes the foam). In addition, processing aids and foaming agents (blowing agents) are often used in the manufacture of foams. These are typically non-covalently bonded low molecular weight materials. In adhesive-foam adhesive constructions, the processing aids and foaming agents can migrate from the foams into the adhesives where they can potentially induce deleterious changes of the adhesive characteristics by chemically modifying the materials or by blooming to the interface of the adhesive and the substrates and thereby forming weak boundary layers.

It is desirable for many applications to utilize a dual functional tape in many of the previously noted applications. It would be particularly desirable to provide a dual functional tape that includes both a LSE adhesive for LSE substrates, and an acrylic pressure sensitive adhesive for other substrates. Ideally, such tapes and adhesive constructions would address and/or overcome many or all of the noted challenges.

### SUMMARY

In one aspect, the present subject matter provides an adhesive tape suitable for adhering articles to a target substrate. The adhesive tape can be used in a variety of applications including, for example, automotive applications for bonding an article to an interior or exterior surface of an automobile. The adhesive can provide a substantially permanent bond between an article and the target substrate.

In one aspect, the present subject matter provides an adhesive tape construction that exhibits excellent properties when bonded to a target substrate having a low surface energy surface. In one embodiment, the adhesive tape exhibits excellent adhesive properties when adhered to a target substrate coated with an acrylic based composition (e.g., an acrylic based paint).

In another aspect, the present subject matter provides an adhesive tape construction that exhibits excellent properties when bonded to a target substrate having a low surface energy surface without the use of primers. In one embodiment, the adhesive tape exhibits excellent adhesive properties when adhered to a target substrate coated with an acrylic based composition (e.g., an acrylic based paint).

In another aspect, the present subject matter provides an adhesive tape which is double sided, i.e., having two exposed faces each oppositely directed from one another. The adhesive tape can be used to adhere or bond articles to a target substrate. The tape can be suitable for bonding an article to a target substrate that exhibits a low surface energy, in which the article exhibits a regular or higher surface energy substrate. Thus, one adhesive face of the tape bonds to the article exhibiting the regular or higher surface energy, and the other adhesive face of the tape bonds to the substrate exhibiting the low surface energy.

In yet another aspect, the present subject matter provides an adhesive tape comprising a core having a first surface and a second surface opposite the first surface, a first adhesive layer disposed on at least a portion of the first surface, and a second adhesive layer disposed on at least a portion of the second surface, where at least one of the first and second adhesive layers comprises a radiation curable rubber based pressure sensitive adhesive.

In certain embodiments, the first adhesive layer comprises a radiation curable rubber based pressure sensitive adhesive and the second adhesive layer comprises an acrylic pressure sensitive adhesive.

In certain embodiments, the core comprises a foam material. In one embodiment, the core comprises a polyolefin based foam. In another embodiment, the core comprises an acrylic foam.

In still additional embodiments, various methods are provided for forming adhesive tapes.

The foam tapes comprising the radiation curable, rubber based adhesives have been found to exhibit excellent adhesive properties when bonded to a target substrate. In particular, the side of the tape with the radiation curable, rubber based adhesive exhibits superior adhesion to conventional acrylic adhesive when adhered to surfaces having low surface energy.

In one embodiment, both the first and second adhesive layers comprises a radiation curable rubber-based pressure sensitive adhesive.

In one embodiment, the core comprises a foam material. In one embodiment, the core comprises a polyolefin-based foam. In one embodiment, the core comprises a polyethylene foam.

The foam tapes comprising the radiation curable, rubber-based adhesives have been found to exhibit excellent adhesive properties when bonded to a target substrate. In particular, the tape constructions have been found to have adhesive properties superior to conventional acrylic adhesive composition when adhered to surfaces having low surface energy.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic side view of an adhesive tape construction in accordance with an embodiment of the present subject matter.

FIG. 2 is a schematic side view of an adhesive article comprising an adhesive tape construction in accordance with another embodiment of the subject matter.

FIG. 3 is a schematic side view of another adhesive tape construction in accordance with another embodiment of the present subject matter.

FIG. 4 is a schematic side view of another adhesive tape construction in accordance with another embodiment of the present subject matter.

FIG. 5 is a schematic side view of another adhesive tape construction in accordance with another embodiment of the present subject matter.

### DETAILED DESCRIPTION OF THE EMBODIMENTS

The present subject matter provides an array of adhesive tapes. In many embodiments, the present subject matter provides a double-sided adhesive tape. In certain embodiments, differential dual functioning articles such as tapes are provided. The adhesive tapes can be used to adhere or bond articles to a target substrate. The tapes can be particularly suitable for bonding an article to a target substrate exhibiting a low surface energy.

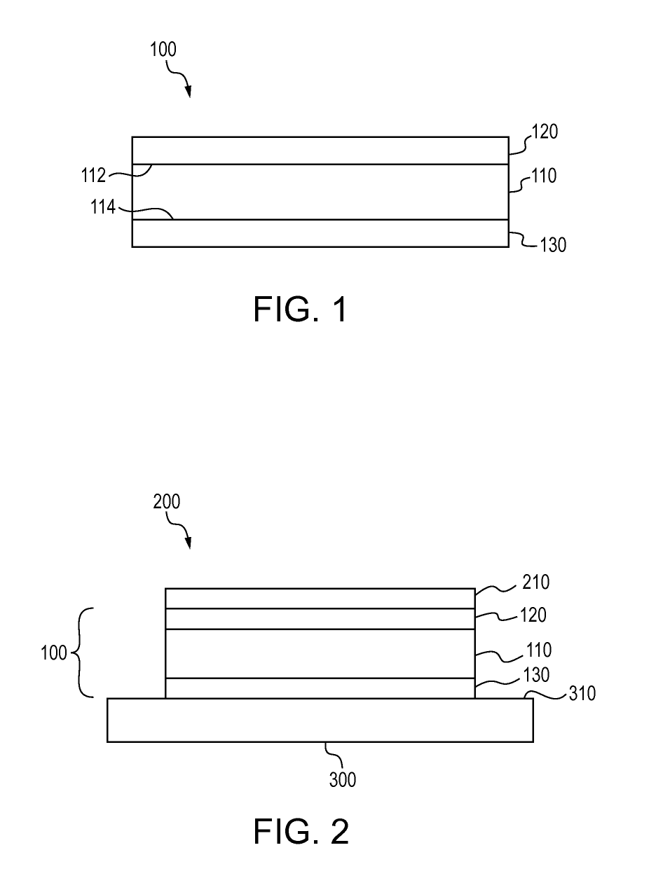

FIG. 1 schematically illustrates an embodiment of a double-sided tape. Double-sided tape 100 comprises a core 110 having a first surface 112 and a second surface 114 opposite the first surface, a first adhesive 120 disposed on the first surface 112, and a second adhesive 130 disposed on the second surface 114. In the embodiment, the core 110 comprises a foam material of polyethylene or acrylic.

The core layer in the double-sided adhesive tapes described herein can be formed from a foam material. The foam material is not particularly limited. In certain embodiments, the foam can be a rigid foam, a semi-rigid foam, a flexible foam, etc. The foam can be an open cell foam or a closed cell foam. In particular embodiments, the foam can be a flexible foam that can be bent back upon itself without fracturing. Examples of suitable foam materials include polyolefin based foams, polyurethane foams, acrylic foams, vinyl foams (e.g., PVC foams), etc. Combinations of these materials can also be used. Polyolefin foams include, but are not limited to, foams formed from polyolefins, copolymers of polyolefins with other monomers, copolymers of polyolefins with acrylics, copolymers of polyolefins with vinyl acetates, etc. In one embodiment, the foam is chosen from a polyethylene foam or a polypropylene foam. In one embodiment, the foam comprises poly(ethylene-co-vinylacetate).

The properties of the foam can be selected as desired for a particular purpose or intended use. In one embodiment, the foam can have a density of 40 kg/m³ to about 300 kg/m³; from about 60 kg/m³ to about 200 kg/m³; even from about 90 kg/m³ to about 150 kg/m³. The core layer can have a thickness as desired for a particular purpose or intended application. In one embodiment, the core layer has a thickness of from about 0.2 mm to about 3 mm; from about 0.4 mm to about 2 mm; from about 0.6 mm to about 1.5 mm; even from about 0.8 mm to about 1 mm. Here as elsewhere in the specification and claims, numerical values can be combined to form new and non-disclosed ranges.

In certain embodiments, at least one of the adhesive layers comprises a radiation curable rubber based adhesive. In one embodiment, both the first adhesive layer and the second adhesive layer comprises a radiation curable rubber-based adhesive. In one embodiment, at least the adhesive layer that will be adhered to or contact the target substrate comprises a radiation curable rubber based adhesive. In another embodiment, both the adhesive layers, comprise a radiation curable rubber-based adhesive. The adhesive layers can have the same composition or can have different compositions in terms of the components used to form the adhesive and/or the amount of the respective components in the composition. In certain embodiments, an adhesive tape or double-sided tape comprises a layer of a rubber based adhesive and a layer of an acrylic adhesive. The adhesive layers are disposed on oppositely directed faces of a core or other intermediate layer of the adhesive tape.

As described herein, in certain embodiments, the adhesive tapes and articles of the present subject matter include one or more pressure sensitive adhesives (PSAs). A description of useful pressure sensitive adhesives may be found in Encyclopedia of Polymer Science and Engineering, Vol. 13, Wiley-Interscience Publishers (New York, 1988). Additional description of useful PSAs may be found in Encyclopedia of Polymer Science and Technology, Vol. 1, Interscience Publishers (New York, 1964).

The base PSA can be acrylic based such as those taught in U.S. Pat. No. 5,164,444 (acrylic emulsion), U.S. Pat. No. 5,623,011 (tackified acrylic emulsion) and U.S. Pat. No. 6,306,982. The adhesive can also be rubber based such as those taught in U.S. Pat. No. 5,705,551 (rubber hot melt). The adhesive can also include a radiation curable mixture of monomers with initiators and other ingredients such as those taught in U.S. Pat. No. 5,232,958 (UV cured acrylic) and U.S. Pat. No. 5,232,958 (EB cured). The disclosures of these patents as they relate to acrylic adhesives are hereby incorporated by reference.

In certain embodiments, commercially available PSAs are useful in the present subject matter. Examples of these adhesives include the hot melt PSAs available from H. B. Fuller Company, St. Paul, Minn. as HM-1597, HL-2207-X, HL-2115-X, HL-2193-X. Other useful commercially available PSAs include those available from Century Adhesives Corporation, Columbus, Ohio. Another useful acrylic PSA comprises a blend of emulsion polymer particles with dispersion tackifier particles as generally described in Example 2 of U.S. Pat. No. 6,306,982. The polymer is made by emulsion polymerization of 2-ethylhexyl acrylate, vinyl acetate, dioctyl maleate, acrylic and methacrylic comonomers as described in U.S. Pat. No. 5,164,444 resulting in the latex particle size of about 0.2 microns in weight average diameters and a gel content of about 60%.

Conventional PSAs, including silicone-based PSAs, rubber based PSAs, and acrylic-based PSAs are useful. An example of a commercially available hot melt adhesive is H2187-01, sold by Ato Findley, Inc., of Wauwatosa, Wis. In addition, rubber based block copolymer PSAs described in U.S. Pat. No. 3,239,478 also can be utilized in the adhesive constructions of the present subject matter.

Polymers used in formulating the rubber based pressure sensitive adhesives can be based on natural and/or synthetic elastomeric polymers. Examples of suitable polymers include, but are not limited to, AB, ABA, and (AB)ₓ block copolymers wherein x has a value of 3 or more and wherein A is a block comprising at least one monoalkenyl arene, such as styrene, alpha methyl styrene, vinyl toluene and the like, and B is an elastomeric conjugated diene block, such as a polybutadiene or a polyisoprene block, etc.

Useful elastomeric polymers include, but are not limited to, natural rubber (polyisoprene), polybutadiene, synthetic polyisoprene, random styrene-butadiene copolymers, styrene-butadiene (SB) block copolymers, multi-armed (SB)ₓ block copolymers, styrene-butadiene-styrene (SBS) block copolymers, styrene-isoprene (SI) block copolymers, styrene-isoprene-styrene (SIS) block copolymers, multi-armed styrene-isoprene (SI)ₓ block copolymers, etc. Combinations of these can also be used.

Commercially available elastomeric polymers used include linear SIS/SI block copolymers known as KRATON D-1107 and D-1112, SBS/SB block copolymers known as KRATON D-1101, D-1102 and DX-1300, and an (SI)ₓ block copolymer known as KRATON D-1320X all manufactured and sold by Shell Chemical Company, and an SB block copolymer known as SOLPRENE 1205 manufactured and sold by Housemex, Inc. In many of the SIS or SBS block copolymers, there are respectively present SI or SB components.

Other elastomers, such as the ethylene-propylene diene rubbers, styrene-ethylene/butylene-styrene block copolymers, styrene-ethylene/propylene-styrene block copolymers, etc. can also be used.

The adhesive compositions typically further comprise a crosslinking agent. In one embodiment, the crosslinking agent can be selected from a polyfunctional acrylate or methacrylate. In another embodiment, the crosslinking agent can be chosen from a polythiol.

A polythiol crosslinking agent is used to enhance the high temperature properties of the rubber based pressure sensitive adhesive. Particularly suitable polythiols include those in which the thiol group is connected to the balance of the polymer chain through an ester linkage.

Examples of suitable functional polythiols that can be used include, but are not limited to, pentaerythritoltetrathioglycolate (PETTG), dipentaerythritoltetra(3-mercaptopropionate), pentaerythritoltetra(3-mercaptopropionate) (PETMP), trimethylolethanetrimercaptopropionate (TMETMP), trimethylolpropanetrithioglycolate (TMPTG), glycoldimercaptoacetate, 2,2,dimercaptodiethylether, polyethyleneglycoldimercaptoacetate, polyethyleneglycol(3-mercaptopropionate, trimethyloltri(3-mercaptopropionate), trimethylolpropanetri(3-mercaptopropionate) (TMFTMP), etc. Combinations of any of these can also be used. The polythiol concentration can range from up to about 10% by weight or more of the rubber, in one embodiment from about 0.1% to about 1% by weight based on the total weight of the rubber, even from about 0.3% to about 0.6% by weight based on the total weight of the rubber.

If an acrylic adhesive is used in the tape or adhesive article, a wide array of acrylic adhesive compositions can be utilized. It is contemplated that any acrylic based polymer capable of forming an adhesive layer with sufficient tack to adhere to a substrate may function in the present subject matter. In certain embodiments, the acrylic polymers for the pressure sensitive adhesive layers include those formed from polymerization of at least one alkyl acrylate monomer containing from about 4 to about 12 carbon atoms in the alkyl group, and present in an amount from about 35% to 95% by weight of the polymer or copolymer, as disclosed in U.S. Pat. No. 5,264,532. Optionally, the acrylic based pressure sensitive adhesive might be formed from a single polymeric species.

The adhesive compositions can also include a tackifier. The tackifier can include one or more tackifiers including normally liquid and/or solid tackifiers. Suitable tackifier systems include conventional tackifiers and plasticizers and oils.

Examples of suitable tackifiers include the WINGTACK family of resins with the numerical designation being the softening point, e.g., WINGTACK 95 which is normally a solid resin having a softening point of about 95° C. and WINGTACK 10 which is normally a liquid resin having a softening point of about 10° C.

Other normally solid tackifiers include, but are not limited to, ESCOREZ 1310 LC manufactured by Exxon and PICCOTAC 95 manufactured by Hercules.

Still other specific tackifiers that can be employed include, but are not limited to, hydrogenated styrene based resins such as REGALREZ resins designated as 1018, 1033, 1065, 1078, 1094 and 1126 manufactured and sold by Hercules, Inc. of Wilmington, Del.; REGALREZ 6108, a 60% hydrogenated aromatic resin also manufactured by Hercules; hydrogenated C₅ and/or C₉ hydrocarbon resin feed stocks such as ARKON P-70, P-90, P-100, P-115, M-90, M-100, M-110 and M-120 resins manufactured and sold by Arakawa Chemical Industries, Ltd of Osaka, Japan, and REGALITE R-100, R-1125, MGB-63, MGB-67, MGB-70 resins manufactured and sold by Hercules, Inc.; hydrogenated polycyclo-pentadienes such as ESCOREZ 5320, 5300, 5380 and 54000 resins manufactured and sold by ExxonMobil Chemical Corporation of Irving, Tex.; hydrogenated polyterpene and other naturally occurring resins such as CLEARON P-105, P-115, P-125, M-105, M-115 manufactured and sold by Yasuhara Yushi Kogyo Co. Ltd. of Hiroshima, Japan, and EASTOTACK H-100, H-100W, H-115, H-130 resins and the like manufactured and sold by Eastman Chemical Company of Kingsport, Tenn.; and KAYDOL hydrogenated mineral oil manufactured and sold by Witco Chemical Corp. of Cranford, N.J., and the like. The PSA compounds disclosed herein can contain between 5% and 50% by weight tackifiers.

There can also be added rosins, rosin esters, polyterpenes and other tackifiers. Other additives include plasticizer oils such as SHELLFLEX 371 manufactured by Shell and KAYDOL mineral oil manufactured by Witco which are soluble in both the polyisoprene and polybutadiene phases.

The tackifier or tackifier system can be present in an amount, based on the total weight of tackifier system and elastomers, of from about 50% to about 80% by weight; from about 50% to about 70% by weight; even from about 60% to about 70% by weight.

The adhesive compositions can be formulated as hot melt adhesives, solvent adhesives, emulsion adhesives, etc.

In certain embodiments of the present subject matter, one or both adhesive layers disposed on oppositely directed faces of a core or other intermediate layer may be in particular combinations. For example, in certain versions of the present subject matter, one adhesive layer comprises a PSA and the other adhesive layer comprises a structural adhesive. A particular example is the use of an acrylic PSA in one layer and in the other layer, a PSA that at least partially transforms to a structural adhesive such as for example after heat curing. Another example is a rubber based PSA which is crosslinked such as for example by appropriate exposure to electron beam (EB or “E-beam”) radiation in one layer, and in the other layers, a structural adhesive.

The acrylic pressure sensitive adhesive can be prepared by combining certain high molecular weight acrylic based copolymers with a tackifier along with in-line mixed aziridine and initially curing the combination by exposure to heat.

Properties of the pressure sensitive adhesive composition can be enhanced by free radical cure, with free radicals preferably generated by electron beam (EB) radiation, or actinic radiation, such as ultraviolet (UV) curing, with or without photoinitiators and/or photosensitizers. Curing can overcome a major deficiency of pressure sensitive adhesives based on unsaturated elastomeric polymers, namely, to have acceptable elevated temperature cohesive strength. Crosslinking of the base polymer(s) in the rubber can enhance cohesive properties of the adhesives especially to improve elevated temperature shear performance.

When electron beam (EB) is employed as the energy source to increase high temperature properties, the normal levels can range from about 1 to about 100 kiloGray (kGy) and in certain embodiments from about 10 to about 50 kGy. An alternative that can be used is ultraviolet radiation. UV irradiation requires the use of a photoinitiator and can be employed in conjunction with EB radiation. When employing resin modification of a pressure sensitive adhesive, non-curing resins are typically employed because resins that undergo cure can diminish the improvement in high temperature properties realized in accordance with the present subject matter.

In operation, the pressure sensitive adhesive is typically cast onto a substrate, either onto a face material or a release layer, and subjected to radiation cure (EB, UV or a combination of the two). Curing can be open face curing, i.e., exposure directly to the surface of the adhesive or through an energy transparent surface such as Mylar. Cure can be of a composite stock, i.e. face material, adhesive and release liner, or in a configuration when after curing, the pressure sensitive adhesive and face material is wound into a roll or tape.

One benefit of using a polythiol as the crosslinking agent is that less agent and energy are used to achieve the same degree of elevated temperature shear properties with minimal reduction in ambient temperature properties as compared with other multifunctional monomers such as multifunctional acrylates and methacrylates.

As noted, in certain embodiments, one or more structural adhesives can be used in the adhesive articles and tapes of the present subject matter. In particular versions, the pressure sensitive adhesive is normally tacky and forms a pressure sensitive adhesive bond at room temperature and heat activation is supplanted by a structural adhesive bond. This can be achieved by distributing on one or both sides of a layer of structural adhesive a thin skin of a pressure sensitive adhesive. If the pressure sensitive adhesive is applied to only one side of the structural layer, the other side of the structural layer can be prebonded to a backing or face stock. The skin or skins of pressure sensitive adhesive can be either continuous or discontinuous layers. Various different pressure sensitive adhesives can be used for the skin layer or layers. For example, either acrylic or rubber based pressure sensitive adhesive(s) may be used. Combinations of these may be used. Additionally, the pressure sensitive adhesive can be either one that is inherently tacky or one that requires addition of a tackifier prior to bonding. The structural adhesive layer is made up of various different structural adhesives such as a partially cured B stage structural adhesive or a blend of epoxy with an acrylate ester resin and hardener. While the skin or skins of pressure sensitive adhesive provide the initial tack, these layers can be absorbed into the core layer by heat activation. This unique feature provides a pressure sensitive adhesive with structural adhesive properties after heat activation.

In certain embodiments, a differential dual functioning article can include one side or face having a structural adhesive skin which is initially a PSA that transitions or converts to a structural adhesive after heat curing. Thus, the article can be initially applied as a PSA tape and then heat cured to develop strength. The other side or face of the article can include a PSA layer such as an acrylic PSA or acrylic PSA tape.

In still other embodiments, a differential dual functioning article can include one side or face having a structural adhesive skin and the other side or face having an E-beam crosslinked rubber PSA skin. The E-beam crosslinked rubber PSA skin may be particularly beneficial for adhering to low surface energy substrates.

In still other embodiments, a differential dual functioning article can include a PSA skin which can be transitioned or converted to a structural adhesive and then further transitioned or converted to a PSA layer. The other side or face of the article can include an E-beam crosslinked rubber PSA skin, which as previously noted may be useful for adhering to low surface energy substrates.

The adhesive can be provided on a surface of the core in any suitable manner. In one embodiment, the adhesive is provided on substantially an entire surface of the core. In one embodiment, the adhesive can be provided on a portion of a surface of the core. In another embodiment, the adhesive can be discontinuous or otherwise patterned as may be desired.

The tape can be provided by applying the adhesive layers to the foam core in any suitable manner. In one embodiment, the foam core can be extruded and then at least one adhesive layer is co-extruded. A second adhesive layer can be extruded onto a surface opposite the first adhesive. The second adhesive can be independently extruded or coextruded along with the first adhesive layer. In another embodiment, the adhesive layers can be provided by applying the adhesive layers using any suitable application method including, but not limited to, laminating or coating such as, for example, knife coating, roll coating, gravure coating, rod coating, curtain coating, spray coating, air knife coating, etc. In a further embodiment, adhesive can be applied to both sides of the foam by any known method before winding or rolling such as through the use of a transfer tape. In another embodiment, at least one pressure sensitive adhesive layer is laminated to the first side of the foam core. After lamination of the first side, the laminated construction is wound up into a roll. The laminated construction then can be unwound and laminated on the second side of the foam core with at least one additional adhesive layer. After lamination of the second side, the laminated construction can be wound up. In still another embodiment, a pressure sensitive adhesive skin is laminated to a primer coated acrylic foam core. The skin can be laminated to one side of the core first. After lamination, the laminated construction is wound up into a roll. Another layer such as a pressure sensitive adhesive skin is laminated to the primer coated acrylic foam core, and particularly to a second side of the foam core. After lamination, the laminated construction is wound up into a roll.

For any of the proceeding methods of applying the adhesive, a tie layer may be included between one or both layer of adhesives and the foam core. The tie layer or layers, which may be the same or different when both sides of the foam are adhesive coated, may be used to anchor the adhesive composition, including pressure sensitive adhesives, to the foam core. The composition of the tie layer or layers can be any known or used in the art, including, but not limited to, chlorinated polyolefins, epoxies, polyamides, ethylene acrylic acid copolymers, or a combination of one or more of these. The tie layer formulation may be in the range of from about 1 to about 15% solids. Preferably, the tie layer formulation is from about 4 to about 8% solids. The tie layer or layers can be coated onto the foam layer. The coating can be done by any known method. In one embodiment, the tie layer or layers is coated onto at least one of the sides of the foam core and dried at 60-80 C for 2-3 minutes. The tie layer or layers can be from about 1 to about 10 μm in thickness. The thickness of the tie layer or layers is preferably between about 2 to about 7 μm. In one embodiment a tie layer is applied to the foam core between the foam core and the first adhesive layer. In another embodiment, a tie layer is applied to the foam core between the foam core and the first adhesive layer and another tie layer is applied to the foam core between the foam core and the second adhesive layer.

The adhesive tape can be lined on one or both sides with a liner. The liner for the product or the in-process liner are, for example, a release paper or release film, which in many embodiments includes a release coating. Liner carriers contemplated include, for example, films of polyester or polypropylene, or calendared papers, with or without a dispersion coating or thermoplastic coating.

The adhesive tape exhibits excellent adhesive properties when adhered or bound to a target substrate. In one embodiment, the adhesive tape has a 90° peel adhesion of about 1 N/mm or greater; about 2 N/mm or greater; even about 3 N/mm or greater. This can be an initial adhesion (e.g., after about 20 minutes) or a long term adhesion (e.g., after about 72 hours).

The adhesive tape can have a pluck adhesion value of about 400 kPa or greater; about 450 kPa or greater; about 500 kPa or greater; about 550 kPa or greater; about 600 kPa or greater; about 700 kPa; even about 800 kPa or greater.

The adhesive tape can have a dynamic shear adhesion of about 400 kPa or greater; about 450 kPa or greater; about 500 kPa or greater; about 550 kPa or greater; about 600 kPa or greater; about 700 kPa; even about 800 kPa or greater.

The adhesives can be provided in sheet form and then converted into a construction of a particular shape to be adhered to an article to form an adhesive article. The adhesive articles can then be applied to a target substrate as desired. Referring to FIG. 2, an adhesive article 200 comprises a decorative article 210 and the previously described adhesive tape 100 adhered to the article 210. In FIG. 2, the first adhesive layer 120 is adhered to the article 210. The second adhesive layer 130 is adapted for being adhered to a surface 310 of a target substrate 300. In one embodiment at least one of the adhesive layers 120 and 130 comprises a radiation curable, rubber based adhesive. The surface 310 of the substrate 300 can have a relatively low surface energy.

In one embodiment, the adhesive tapes are suitable for adhering to low surface energy surfaces. In one embodiment, the films can be applied to, and exhibit the adhesion characteristics described herein, when adhered to a surface having a surface energy of about 50 dynes per centimeter or less; about 45 dynes per centimeter or less; about 40 dynes per centimeter or less; about 35 dynes per centimeter or less; even about 32 dynes per centimeter or less. In one embodiment, the surface has a surface energy of from about 5 dynes per centimeter to about 50 dynes per centimeter; about 10 dynes per centimeter to about 45 dynes per centimeter; about 15 dynes per centimeter to about 40 dynes per centimeter; even about 20 dynes per centimeter to about 35 dynes per centimeter. In certain embodiments, the surface has a surface energy of from about 32 dynes per centimeter to about 40 dynes per centimeter. Here as elsewhere in the specification and claims, numerical values can be combined to form new and non-disclosed ranges.

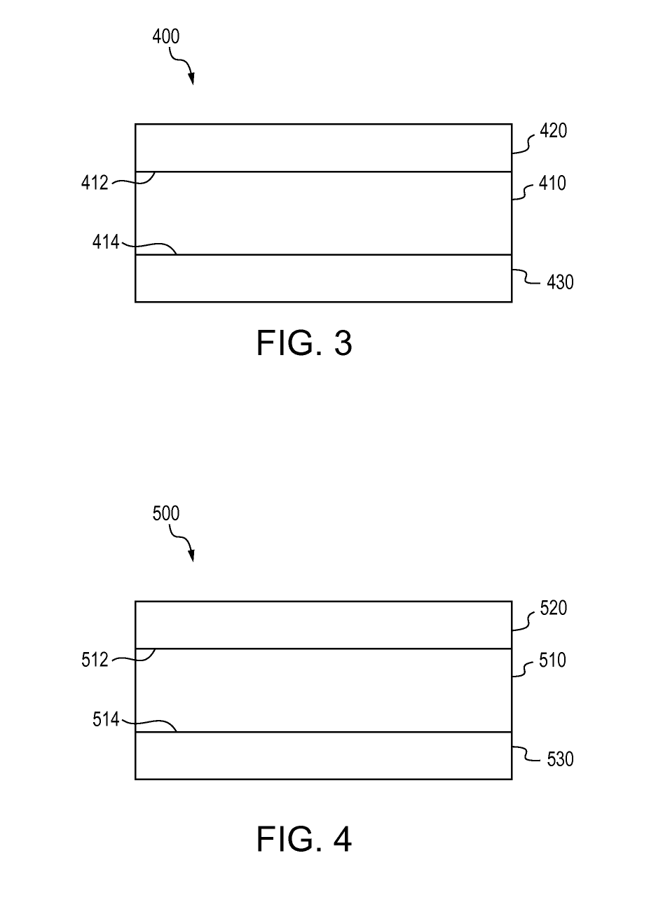

FIG. 3 schematically illustrates another embodiment of a double-sided tape in accordance with the present subject matter. The double-sided tape 400 comprises a core 410 having a first surface 412 and an oppositely directed second surface 414, a first adhesive 420 disposed on the first surface 412, and a second adhesive 430 disposed on the second surface 414. In this embodiment, the first adhesive 420 includes a rubber based adhesive. The core 410 comprises a foam material. And the second adhesive 430 includes an acrylic adhesive.

FIG. 4 schematically illustrates another embodiment of a double-sided tape in accordance with the present subject matter. The double-sided tape 500 comprises a core 510 having a first surface 512 and an oppositely directed second surface 514, a first adhesive 520 disposed on the first surface 512 and a second adhesive 530 disposed on the second surface 514. The first adhesive 520 includes a PSA that at least partially transforms to a structural adhesive upon heat curing. The core 510 comprises a foam material. The second adhesive 530 includes an electron beam (E-beam) crosslinked rubber based PSA.

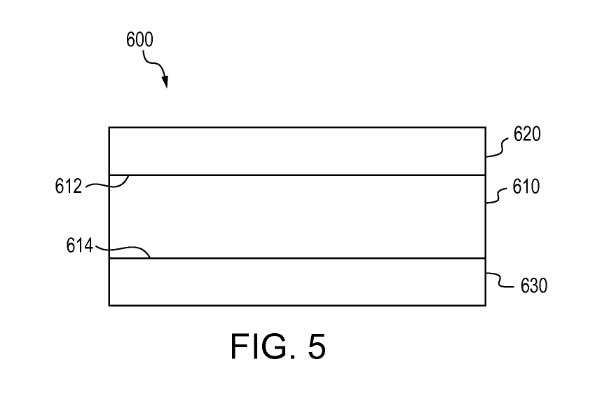

FIG. 5 schematically illustrates yet another embodiment of a double-sided tape in accordance with the present subject matter. The double-sided tape 600 comprises a core 610 having oppositely directed first and second surfaces 612 and 614, respectively, a first adhesive 620 disposed on the first surface 612, and a second adhesive 630 disposed on the second surface 614. The first adhesive 620 includes a PSA that at least partially transforms to a structural adhesive upon application of heat. The core 610 includes a foam material. And the second adhesive 630 includes a PSA skin as described herein.

In certain aspects of the present subject matter, methods of forming adhesive tapes or laminates are also provided. In one version, a foam core is formed or otherwise provided. As described herein, the foam core includes two oppositely directed faces or surfaces. The methods generally include an operation of depositing or otherwise forming a layer of a first adhesive along one of the foam faces, and another layer of a second adhesive along the other foam face. As previously explained herein, the adhesives are typically a rubber based adhesive and an acrylic or acrylic based adhesive. In a particular version of the present subject matter, an adhesive that is initially a PSA is deposited or applied onto a face of the foam core. The PSA is then at least partially transformed into a structural adhesive by heating to thereby achieve a thermal cure or partial thermal cure. Heating can be performed for time periods and at temperatures as are appropriate for the application and the adhesive. Representative time periods for heating include, but are not limited to from about 10 minutes or less to about 2 hours or more, and for many applications from about 10 minutes to about 15 minutes. Typical temperatures range from about 100° C. to about 200° C., and in certain embodiments from about 120° C. to about 180° C., and in particular from about 140° C. to about 150° C. The other, oppositely directed face of the foam core can receive a layer of a second adhesive, or of a second adhesive in combination with still additional adhesives. In certain versions of the present subject matter, after forming the previously noted intermediate laminate that includes a layer of PSA which has been at least partially transformed to a structural adhesive by heat curing, a layer of a rubber based PSA can be deposited along the other face of the foam core. That rubber based PSA can be at least partially crosslinked by exposure to radiation such as an electron beam. In another embodiment of the present subject matter, after forming the previously noted intermediate laminate that includes a layer of a PSA which has been at least partially transformed to a structural adhesive by heat curing, a layer of a PSA skin is formed or otherwise deposited along the other oppositely directed face of the foam core.

The adhesive tapes can be used in a variety of applications. In one embodiment, the adhesive tapes can be used to form adhesive articles for mounting onto a surface of an automobile. The adhesive can be mounted on an exterior surface of an automobile including surfaces having relatively low surface energy.

Aspects of the present subject matter can be further understood with reference to the following examples. The examples are intended to illustrate various embodiments and aspects of the subject matter and are not intended to limit the scope of the subject matter.

### EXAMPLES

### Tape 1

An adhesive tape composition (Tape 1) is formed by providing a polyethylene foam sheet having a first surface and a second surface opposite the first surface, and disposing an adhesive composition on the first and second surfaces of the polyethylene foam sheet. The adhesive composition is comprised of rubbers, resins, and other additives according to the formula of Table 1:

TABLE 1
Adhesive Composition Used in Tape 1

| Component | Weight Percent |
|---|---|
| SBS Rubber (VECTOR 8508) | 30.4 |
| SB Rubber (SOLPRENE 1205) | 5.4 |
| Rosin Ester Tackifier (FORAL 85) | 26.8 |
| Alpha Pinene Tackifier (PICCOLYTE A115) | 29.8 |
| Wood Rosin (HERCOLYN D) | 7.1 |
| Antioxidant (LENOXI AO 612) | 0.5 |

The adhesive layers are coated at 0.06 microns and applied to both sides of the foam.

### Examples 1-7

Properties of the tapes are evaluated by adhering a tape in accordance with Tape 1 to a steel panel having a paint system disposed on the surface of the panel. The following clearcoat paint systems are employed in the Examples 1-7:

TABLE 2
Clearcoat Paint Systems Used in Examples 1-7

| Example | Paint System |
|---|---|
| 1 | DuPont 5W |
| 2 | DuPont 4ES |
| 3 | PPG MAC8000 |
| 4 | BASF Z Clear |
| 5 | BASF 392 |
| 6 | PPG TMAC 8000 |
| 7 | DuPont 5S |

The 90° peel adhesion, pluck adhesion, shear adhesion and liner removal adhesion of the adhesive tape on the paint systems of Examples 1-7 are evaluated based on specification WSS-M11P65 from Ford Motor Company. Specifically, 90° peel adhesion is measured according to Ford Laboratory Test Method FLTM BU 112-02 Method A using a 0.13 mm thick anodized aluminum support. Pluck adhesion is measured according to Ford Laboratory Test Method FLTM BU 112-02 Method E using a 12.7 mm by 25.4 mm sample pulled normal to the panel surface at 25.4 mm/minute. Dynamic shear adhesion is measured by 25.4×25.4 mm square overlap shear with a 25.4 mm by 76.2 mm test panel to an anodized aluminum test panel at 12.7 mm/min.

Tables 3-5 provide the results of the evaluation.

TABLE 3
90° Peel Adhesion for Examples 1-7

| Environment | Spec | Ex. 1 | Ex. 2 | Ex. 3 | Ex. 4 | Ex. 5 | Ex. 6 | Ex. 7 |
|---|---|---|---|---|---|---|---|---|
| 20 min RT | 0.4 | 3.4 | 3.0 | 3.1 | 3.2 | 3.1 | 3.2 | 3.0 |
| 72 hr RT | 0.6 | 3.1 | 3.0 | 2.9 | 3.1 | 3.1 | 3.0 | 2.9 |
| Heat | 1.3 | 3.4 | 3.4 | 3.3 | 3.2 | 3.2 | 3.2 | 3.3 |
| Humidity | 0.7 | 3.2 | 2.7 | 2.9 | 2.8 | 1.1 | 1.2 | 3.1 |
| Cycle | 1.3 | 1.8 | 2.0 | 1.7 | 1.9 | 1.9 | 1.9 | 2.0 |

In Table 3, the units for 90° peel adhesion are N/mm.

TABLE 4
Pluck Adhesion for Examples 1-7

| Environment | Spec | Ex. 1 | Ex. 2 | Ex. 3 | Ex. 4 | Ex. 5 | Ex. 6 | Ex. 7 |
|---|---|---|---|---|---|---|---|---|
| 20 min RT | 450 | 632 | 629 | 651 | 627 | 641 | 620 | 643 |
| 72 hr RT | 450 | 802 | 806 | 813 | 777 | 814 | 759 | 739 |
| Heat | 450 | 1143 | 1174 | 1164 | 1155 | 1156 | 1148 | 1167 |
| Humidity | 450 | 988 | 968 | 901 | 914 | 770 | 881 | 970 |
| Cycle | 450 | 975 | 932 | 970 | 982 | 936 | 964 | 1001 |

In Table 4, the units for pluck adhesion are kPa.

TABLE 5
Dynamic Shear Adhesion for Examples 1-7

| Environment | Spec | Ex. 1 | Ex. 2 | Ex. 3 | Ex. 4 | Ex. 5 | Ex. 6 | Ex. 7 |
|---|---|---|---|---|---|---|---|---|
| 20 min RT | 410 | 758* | 758* | 758* | 758* | 758* | 758* | 758* |
| Heat | 410 | 758* | 758* | 758* | 758* | 758* | 758* | 758* |
| Humidity | 240 | 758* | 758* | 758* | 758* | 758* | 758* | 758* |
| Cycle | 310 | 758* | 758* | 758* | 758* | 758* | 758* | 758* |

In Table 5, the units for dynamic shear adhesion are kPa.
Values noted with “*” exceeded the maximum value of the tensile tester that was used.

As illustrated in Tables 3-5, the adhesive tapes in accordance with aspects of the present subject matter exhibited excellent adhesive properties and far exceeded the requirements for certain OEM specifications.

### Example 8 and Comparative Examples C1-C3

An adhesive tape made as described with respect to Tape 1 is used as Example 8. Comparative tapes C1-C3 are prepared in a similar manner except that acrylic based adhesives are employed in the construction. The following adhesives are employed in tapes C1-C3:

TABLE 6
Adhesives Used in Tapes C1-C3

| Tape | Adhesive |
|---|---|
| C1 | 3M NT4500 S2 |
| C2 | 3M DC2011 S2 |
| C3 | Saint Gobain E545H |

The respective tapes are adhered to a panel coated with PPG's SRC8002 paint system. 90° peel adhesion and pluck adhesion are evaluated using the methods previously described herein. Dynamic shear adhesion and static shear adhesion are evaluated as follows: Dynamic shear adhesion is measured using the previously noted test method. Static shear adhesion is measured by Ford Laboratory Test Method FLTM BU 101-06.

Tables 7 through 10 illustrate the results of the tests conducted with Tape 1 and tapes C1-C3.

TABLE 7
90° Peel Adhesion for Examples 8 and Tapes C1-C3

| Environment | Spec | Ex. 8 | C1 | C2 | C3 |
|---|---|---|---|---|---|
| 20 min RT | 0.4 | 2.7 | 0.3 | 0.4 | 0.6 |
| 72 hrs RT | 0.6 | 2.7 | 0.5 | 0.6 | 0.8 |
| 336 hrs @ 80° C. | 1.3 | 2.5 | 5.3 | 4.8 | 3.2 |
| Cycle | 1.3 | 1.5 | 2.6 | 4.7 | 1.5 |
| 336 hrs @ 38° C. and 98% RH | 0.7 | 1.4 | 2.3 | 5.4 | 1.0 |

In Table 7, the units for 90° peel adhesion are N/mm.

TABLE 8
Pluck Adhesion for Example 8 and Tapes C1-C3

| Environment | Spec | Ex. 8 | C1 | C2 | C3 |
|---|---|---|---|---|---|
| 20 min RT | 450 | 825 | 743 | 760 | 403 |
| 72 hrs RT | 450 | 743 | 800 | 858 | 611 |
| 336 hrs @ 80° C. | 450 | 1070 | 1067 | 993 | 943 |
| Cycle | 450 | 865 | 898 | 925 | 979 |
| 336 hrs @ 38° C. and 98% RH | 450 | 895 | 659 | 754 | 605 |

In Table 8, the units for pluck adhesion are kPa.

TABLE 9
Dynamic Shear Adhesion for Example 8 and Tapes C1-C3

| Environment | Spec | Ex. 8 | C1 | C2 | C3 |
|---|---|---|---|---|---|
| 20 min RT | 410 | 785 | 670 | 767 | 422 |
| 72 hrs RT | 410 | n/a | n/a | n/a | n/a |
| 336 hrs @ 80° C. | 410 | 767 | 649 | 788 | 771 |
| Cycle | 310 | 806 | 815 | 803 | 794 |
| 336 hrs @ 38° C. and 98% RH | 240 | 798 | 747 | 685 | 675 |

In Table 9, the units for dynamic shear adhesion are kPa.

TABLE 10
Static Shear Adhesion for Example 8 and Tapes C1-C3

| Environment | Spec | Ex. 8 | C1 | C2 | C3 |
|---|---|---|---|---|---|
| 100 hrs @ 70° C. | 1 | 0.5 | 0 | 0.5 | 0 |
| 30 min @ 120° C. | 1 | 1 | 0.4 | 0.4 | 0.5 |

In Table 10, the units for static shear adhesion are mm of slip.

As illustrated in Tables 7-10, the adhesive tape in accordance with the present subject matter exhibited excellent performance as compared to similar tapes using commercially available acrylic adhesives.

### Example 9

Tapes in accordance with Tape 1 are prepared and tested against MS-12194 specifications from Chrysler division of the Chrysler Group. Table 11 illustrates the properties of the adhesive against these standards.

TABLE 11
Comparison of Properties of Tape 1 to Chrysler
Specification of Example 9

| | Dynamic | | Dynamic | | | | | |
|---|---|---|---|---|---|---|---|---|
| | Shear | | Shear | | | | | |
| | Adhesion, | | Adhesion, | | Pluck, | | Pluck, | |
| | NCTX | | SRC8002 | | NCTX | | SRC8002 | |
| | (kPa) | | (kPa) | | (kPa) | | (kPa) | |
| Environment | Req | Value | Req | Value | Req | Value | Req | Value |
| Initial-20 min | 400 | 1014 | 350 | 963 | 550 | 887 | 500 | 841 |
| 1 hr RT | 450 | 1014 | 400 | 1012 | 575 | 867 | 525 | 787 |
| 24 hr RT | 550 | 975 | 500 | 1000 | 600 | 900 | 550 | 841 |
| 72 h RT | 600 | 1012 | 550 | 940 | 625 | 837 | 575 | 811 |
| Heat aged | 600 | 1153 | 550 | 1164 | 650 | 1137 | 600 | 1070 |
| Humidity | 575 | 1026 | 525 | 956 | 500 | 630 | 500 | 589 |
| Salt Spray | 575 | 1044 | 525 | 929 | 500 | 572 | 500 | 593 |
| Cycle | 575 | 1078 | 525 | 1107 | 500 | 1024 | 500 | 864 |

Table 11 illustrates that tapes in accordance with the present subject matter exhibited excellent adhesive properties and significantly exceeded the requirements for certain OEM specifications.

### Example 10

Another tape construction was prepared having a foam core and a layer of a rubber based adhesive on each of the oppositely directed faces of the core. Specifically, the foam core included a foamed acrylic. And the rubber based adhesives included electron beam crosslinked rubber based adhesive. This tape construction is referred to herein as Tape 2.

Various comparative measurements were performed between Tape 2 and comparative tapes designated as C4 and C5. Tape C4 is a single foamed acrylic layer with a general purpose acrylic adhesive. Tape C4 does not include adhesive skins. Tape C4 is commercially available from Avery Dennison under the designation AFB 6610G.

Tape C5 is double coated acrylic foam tape available from 3M under the designation PT 1100.

Tape 2 and Tapes C4 and C5 were subjected to 90° peel and dynamic shear adhesion measurements after adhesion to various substrates and under different environmental conditions and time periods. The results of the comparative measurements are set forth below in Table 12.

TABLE 12
Comparison of Adhesion Between Tapes of Example 10

| Test | Details | Substrate | Tape 2 | C4 | C5 |
|---|---|---|---|---|---|
| Adhesions, 90 | 24 hr RT | Aluminum | 30.3 | 26.1 | 26.4 |
| degree, 12 ipm, | | Polypropylene | 29.6 | 0.5 | 1.2 |
| values in | | Carbamate | 18.5 | 0.6 | 2.6 |
| average lbs/in | | ABS | 31.9 | 8.8 | 25.5 |
| | | Acrylic | 8.6 | 0.4 | 1.0 |
| | 72 hr RT | Aluminum | 28.9 | 25.9 | 24.7 |
| | | Polypropylene | 27.0 | 0.7 | 1.5 |
| | | Carbamate | 17.9 | 1.6 | 5.6 |
| | | ABS | 29.4 | 9.8 | 25.1 |
| | | Acrylic | 8.6 | 0.5 | 1.3 |
| | 72 hr humidity | Aluminum | 25.4 | 22.1 | 24.8 |
| | (100%/38° C.) | Polypropylene | 26.5 | 1.5 | 2.0 |
| | | Carbamate | 16.5 | 5.9 | 26.3 |
| | | ABS | 27.5 | 10.7 | 24.8 |
| | | Acrylic | 7.4 | 1.4 | 1.5 |
| | 72 hr 80° C. | Aluminum | 34.6 | 33.0 | 25.5 |
| | | Polypropylene | 30.9 | 0.6 | 1.5 |
| | | Carbamate | 32.1 | 33.1 | 25.4 |
| | | ABS | 33.6 | 1.3 | 24.6 |
| | | Acrylic | 2.6 | 4.5 | 19.1 |
| Dynamic shear, | 24 hr RT | Aluminum | 93 | 40 | 47 |
| 1 inch × 1 | 72 hr RT | Aluminum | 100 | 95 | 55 |
| inch, 2 ipm, | 72 hr humidity | Aluminum | 79 | 47 | 46 |
| values in peak | (100%/38° C.) | | | | |
| lbs | 72 hr 80° C. | Aluminum | 89 | 47 | 48 |

As demonstrated by the testing results presented in Table 12, the embodiment of the present subject matter, i.e., Tape 2, exhibited relatively high adhesion to polypropylene substrates. This is an indication of high adhesion to a low surface energy substrate (LSE) such as polypropylene, without degrading adhesion to other substrates.

The examples illustrate that the adhesive tapes in accordance with aspects of the subject matter exhibit excellent adhesive properties under a variety of conditions. The tapes exhibit excellent adhesive properties when bonded to surfaces having a low surface energy and even under high temperature conditions.

Many other benefits will no doubt become apparent from future application and development of this technology.

All patents, published applications, and articles noted herein are hereby incorporated by reference in their entirety.

All of the features disclosed in the specification, including the claims, abstract, and drawings, and all of the steps or operations in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present subject matter is provided for purposes of illustration, and it is not intended to be exhaustive or to limit the subject matter to the particular embodiments disclosed. The embodiments may provide different capabilities and benefits, depending on the configuration used to implement the key features of the subject matter. Accordingly, the scope of the subject matter is defined only by the following claims.

What is claimed is:

1. An adhesive tape comprising:
a core layer comprising a foam material and having a first surface and a second surface opposite the first surface;
a first adhesive layer disposed on the first surface; and
a second adhesive layer disposed on the second surface, wherein at least one of the first adhesive layer and second adhesive layer comprises a radiation curable rubber based adhesive.

2. The adhesive tape of claim 1, wherein the core layer comprises a foam material selected from the group consisting of a polyolefin based foam, a polyurethane foam, an acrylic foam, a vinyl foam and combinations thereof.

3. The adhesive tape of claim 1, wherein the core layer comprises a polyethylene foam.

4. The adhesive tape of claim 1, wherein the core layer has a density within a range of from about 40 kg/m³ to about 300 kg/m³.

5. The adhesive tape of claim 1, wherein the core layer has a density within a range of from about 60 kg/m³ to about 200 kg/m³.

6. The adhesive tape of claim 1, wherein the radiation curable rubber based adhesive comprises an elastomeric polymer selected from the group consisting of natural rubber (polyisoprene), polybutadiene, synthetic polyisoprene, random styrene-butadiene copolymers, styrene-butadiene (SB) block copolymers, multi-armed (SB)ₓ block copolymers, styrene-butadiene-styrene (SBS) block copolymers, styrene-isoprene (SI) block copolymers, styrene-isoprene-styrene (SIS) block copolymers, multi-armed styrene-isoprene (SI)ₓ block copolymers, and combinations thereof.

7. The adhesive tape of claim 1, wherein the radiation curable rubber based adhesive comprises a crosslinking agent comprising a polythiol.

8. The adhesive tape of claim 7, wherein the polythiol is selected from the group consisting of pentaerythritoltetrathioglycolate (PETTG), dipentaerythritoltetra(3-mercaptopropionate), pentaerythritoltetra(3-mercaptopropionate) (PETMP), trimethylolethanetrimercaptopropionate (TMETMP), trimethylolpropanetrithioglycolate (TMPTG), glycoldimercaptoacetate; 2,2,dimercaptodiethylether, polyethyleneglycoldimercaptoacetate, polyethyleneglycol(3-mercaptopropionate, trimethyloltri(3-mercaptopropionate), trimethylolpropanetri(3-mercaptopropionate) (TMFTMP), and combinations thereof.

9. The adhesive tape of claim 1, when bound to a target substrate, exhibits a 90° peel adhesion of about 1 N/mm or greater.

10. The adhesive tape of claim 1, when bound to a target substrate, exhibits a pluck adhesion of about 400 kPa or greater.

11. The adhesive tape of claim 1 having, when bound to a target substrate, exhibits a dynamic shear adhesion of about 400 kPa or greater.

12. The adhesive tape of claim 1 wherein the first adhesive layer comprises a radiation curable rubber based adhesive and the second adhesive layer comprises an acrylic adhesive.

13. The adhesive tape of claim 1 wherein the first adhesive layer is initially a pressure sensitive adhesive which upon heating converts to a structural adhesive.

14. The adhesive tape of claim 13 wherein the second adhesive layer includes the radiation curable rubber based adhesive.

15. The adhesive tape of claim 14 wherein the radiation curable rubber based adhesive is an E-beam crosslinked rubber based adhesive.

16. The adhesive tape of claim 13 wherein the first adhesive layer after conversion to the structural adhesive can be further converted to a pressure sensitive adhesive.

17. The adhesive tape of claim 1 wherein the first adhesive layer is a structural adhesive.

18. The adhesive tape of claim 17 wherein the second adhesive layer includes the radiation curable rubber based adhesive.

19. The adhesive tape of claim 18 wherein the radiation curable rubber based adhesive is an E-beam crosslinked rubber based adhesive.

20. An adhesive tape comprising:
a core layer comprising a foam material and having a first surface and a second surface opposite the first surface;
a first adhesive layer disposed on the first surface, the first adhesive layer comprising a pressure sensitive adhesive; and
a second adhesive layer disposed on the second surface, the second adhesive layer comprising a structural adhesive.

21. The adhesive tape of claim 20 wherein the pressure sensitive adhesive is selected from the group consisting of an acrylic adhesive, a rubber based adhesive, and combinations thereof.

22. The adhesive tape of claim 20 further comprising:
an adhesive skin layer disposed on the second adhesive layer, the adhesive skin layer comprising a pressure sensitive adhesive.

23. An adhesive article comprising:
an article to be bonded to a target substrate; and
the adhesive tape of claim 1.

24. A structure comprising an adhesive article bonded to a surface of a target substrate, the adhesive article comprising the adhesive tape of claim 1 disposed between the adhesive article and the target substrate.

25. The structure of claim 24, wherein the surface of the target substrate has a low surface energy.

26. The structure of claim 24, wherein the surface of the target substrate has a surface energy of about 50 dynes per centimeter or less.

27. The structure of claim 24, wherein the surface of the target substrate has a surface energy of about 35 dynes per centimeter or less.

28. The structure of claim 24, wherein the surface of the target substrate has a surface energy of about 32 dynes or less.

29. The structure of claim 24, wherein the surface of the target substrate has a surface energy of from about 5 dynes per centimeter to about 50 dynes per centimeter.

30. The structure of claim 24, wherein the surface of the target substrate has a surface energy of from about 32 dynes per centimeter to about 40 dynes per centimeter.

31. A method of adhering an article to a substrate comprising:
providing an article comprising an adhesive tape according to claim 1; and
applying the article to a target substrate by adhering an adhesive layer of the adhesive tape to the substrate to thereby adhere the article to the substrate.

32. The method of claim 31, wherein the target substrate has a surface energy of about 50 dynes per centimeter or less.

33. The method of claim 31, wherein the target substrate has a surface energy of about 35 dynes per centimeter or less.

34. The method of claim 31, wherein the target substrate has a surface energy of about 32 dynes per centimeter or less.

35. The method of claim 31, wherein the surface of the target substrate has a surface energy of from about 5 dynes per centimeter to about 50 dynes per centimeter.

36. A method of forming an adhesive tape, the method comprising:
providing a foam core having a first surface and a second surface oppositely directed from the first surface;
depositing a first adhesive on the first surface to thereby form a first adhesive layer;
depositing a second adhesive on the second surface to thereby form a second adhesive layer, wherein at least one of the first adhesive layer and the second adhesive layer includes a radiation curable rubber based adhesive;
exposing at least one of the first adhesive layer and the second adhesive layer which includes the rubber based adhesive to radiation to thereby at least partially cure the layer.

37. The method of claim 36 wherein the first adhesive layer includes the radiation curable rubber based adhesive and the second adhesive layer includes an acrylic adhesive.

38. The method of claim 36 wherein the foam core includes a foam material selected from the group consisting of a polyolefin based foam, a polyurethane foam, an acrylic foam, a vinyl foam, and combinations thereof.

39. A method of forming an adhesive tape, the method comprising:
providing a foam core having a first surface and a second surface oppositely directed from the first surface;
depositing a pressure sensitive adhesive on the first surface to thereby form a first adhesive layer;
heating the first adhesive layer to thereby at least partially transform the pressure sensitive adhesive to a structural adhesive.

40. The method of claim 39 wherein heating is performed for a time period of from about 10 minutes to about 15 minutes.

41. The method of claim 39 wherein heating is performed such that the temperature of the first adhesive layer is in a range of from about 140° C. to about 150° C.

42. The method of claim 39 further comprising:
forming a second adhesive layer on the second surface of the foam core.

43. The method of claim 42 wherein the second adhesive layer includes a rubber based pressure sensitive adhesive.

44. The method of claim 43 further comprising:
exposing the second adhesive layer including the rubber based pressure sensitive adhesive to radiation to thereby at least partially cure the second adhesive layer.

45. The method of claim 44 wherein the radiation is electron beam radiation.

46. The method of claim 42 wherein the second adhesive layer includes a pressure sensitive adhesive skin.
